(19) United States
(12) Patent Application Publication
(10) Pub. No.: US 2016/0319187 A1
(43) Pub. Date: Nov. 3, 2016

(54) BORON SEQUESTRATION IN FRACTURING FLUIDS

(71) Applicant: SANJEL CANADA LTD., Calgary (CA)

(72) Inventors: Sally LAWRENCE, Calgary (CA); Neil WARRENDER, Calgary (CA); Jaclyn FOSTER, Calgary (CA); Timothy WASDAL, Calgary (CA)

(73) Assignee: SANJEL CANADA LTD., Calgary (CA)

(21) Appl. No.: 15/137,792

(22) Filed: Apr. 25, 2016

Related U.S. Application Data
(60) Provisional application No. 62/151,737, filed on Apr. 23, 2015.

(51) Int. Cl. C09K 8/68; C09K 8/90

(52) U.S. Cl. CPC C09K 8/685; C09K 8/90

(57) ABSTRACT

A method of sequestering boron species in a fracturing fluid includes the use of a boron chelating agent. Also disclosed are methods of producing a fracturing fluid using produced or recycled base fluids which may be contaminated with boron, and methods of stimulating of hydrocarbon-bearing formations using such fracturing fluids.

### FIELD OF THE INVENTION

The present invention relates to methods of sequestering boron species in a fracturing fluid, fracturing fluids comprising a boron sequestration agent, and methods of stimulating of hydrocarbon-bearing formations using such fracturing fluids.

### BACKGROUND

The production of oil and gas wells has been enhanced through the technique of hydraulic fracturing. The fracturing process typically involves injecting water, a gelling agent, and proppant under pressure into the subterranean formations that are oil and gas bearing to create a network of microcracks. The proppant holds the cracks open when the pressure from the injected fluids is released, thus maintaining flow paths for oil and gas to flow through the subterranean formation to the wellbore, where it can be collected and produced to the surface.

Aqueous-based fracturing fluids for hydrocarbon recovery operations are typically formulated with chemical additives which enhance fracture creation and proppant carrying capabilities. Such additives include viscosifying polymers, cross-linking agents, proppants, friction reducers, temperature stabilizers, pH buffers, biocides, fluid loss control additives, and oxygen control additives. Formation damage may be mitigated with additives such as scale inhibitors, iron control agents, non-emulsifiers, clay stabilizers, and polymer breakers for problems such as clean-up of the proppant pack, clay swelling, precipitation of solids, migration of fines, scale from injection and formation water incompatibility, oil/water emulsions, and water blocks.

The desire to reduce the amount of fresh water used to make the aqueous base fluid fracturing fluids has caused increased use of non-potable water sources such as recycled and produced water in hydraulic fracturing operations. This in turn has resulted in the need for fracturing fluid systems to be more robust and tolerate higher levels of salinity, non-neutral pH, and high levels of both naturally occurring and residual contaminants.

Produced water or recycled water may contain significant amounts of contaminants, such as salts, metals and metalloids such as boron. Boron occurs naturally in some waters, typically as boric acid or borate. Incompatibility arises because these boron-containing species are also used as additives to cross-link the gels used to hold the proppant in suspension in the fracturing fluid. While borate is commonly used in a controlled amount as a cross-linking agent after hydration of the polymer gelling agent is complete, any borate already present in the water being used to hydrate the polymer gellant will inhibit its hydration and interfere with gel cross-linking. Therefore, the free borate concentration in the base water of the fracturing fluid must be controlled to ensure proper hydration and cross-linking of the gel. Produced water may have naturally high boron levels, or boron levels may build up and exceed a desired level when fluids are recycled and reused.

Prior art efforts to remove boron from waters to be used to build a fracturing fluid have adapted prior art technology that has been used in water desalination plants. This technology uses resin ion exchange beds to remove boron-containing species. As the amount of boron removed from the water increased, the effectiveness of the ion exchange bed decreases and eventually ceases until the resin bed is chemically regenerated. This solution adds time, complexity and additional cost to a fracturing operation, as the streams of contaminated and purified waters must be kept separate, and requires additional energy for the pumping equipment.

Therefore, there is a need in the art for methods and compositions for mitigating the presence of borate in a fracturing fluid.

### SUMMARY OF THE INVENTION

In one aspect, the invention comprises a fracturing fluid comprising:

(a) an aqueous base fluid comprising one or more boron-containing species;

(b) a hydrated polysaccharide gelling agent; and

(c) a non-polymer borate chelating agent comprising a cis-diol moiety.

In one embodiment, the aqueous base fluid comprises produced or recycled water. In one embodiment, the chelating agent further comprises an amine or amide group. In one embodiment, the cis-diol chelating agent comprises a polyhydric sugar alcohol, such as N-methyl-D-glucamine (NMDG), and the polysaccharide gelling agent comprises guar or a guar derivative.

In another aspect, the invention may comprise a method of producing a fracturing fluid, comprising the steps of:
a. using recycled or produced water comprising a boron-containing species, hydrating a polysaccharide gelling agent by: (i) reducing the pH to less than about 7, or (ii) adding a borate chelating agent comprising a cis-diol moiety and adjusting pH to less than about 7;
b. cross-linking the polysaccharide gelling agent by increasing the pH to greater than about 9, optionally with the addition of a cross-linking agent, and controlling borate with the borate chelating agent added in step (a), or additional borate chelating agent.

In another aspect, the invention may comprise a method of stimulating a wellbore using a fracturing fluid comprising water contaminated with boron, comprising the steps of:

(a) hydrating a polysaccharide gelling agent at a pH of less than about 8;

(b) adding a boron chelating agent before or after hydration; and

(c) cross-linking the polysaccharide gelling agent by increasing the pH to greater than about 9, and optionally adding more boron.

### BRIEF DESCRIPTION OF THE DRAWINGS

FIG. 1 illustrates the hydration curve of guar in tap water and a variety of boron concentrations.

FIG. 2 illustrates the hydration of guar in an environment controlled to pH 6.

FIG. 3 shows a similar curve to FIG. 1, with a 1:1 ratio of NMDG to boron

FIG. 4 shows a similar curve to FIG. 3 but with the NMDG:boron ratio at 5:1.

FIG. 5 illustrates a baseline gel stability of a standardized borate cross-linked fluid at 60° C. (approximately 50% w/v guar at 6.0 Lm⁻³, alkaline buffer at 1.5 Lm⁻³, and BX1 at 1.5 Lm

FIG. 6 illustrates gel viscosity results of different concentrations of boron at an alkaline pH.

FIG. 7 illustrates gel viscosity results of different loadings of cross-linker with 200 ppm boron.

FIG. 8 illustrates gel viscosity results with the addition of NMDG.

FIG. 9 illustrates gel viscosity results with the addition of solid NMDG after hydration of the gel.

FIG. 10 illustrates gel viscosity results with the addition of NMDG solution.

FIG. 11 illustrates gel viscosity results with varying orders of addition of solid NMDG and NMDG in solution.

FIG. 12 illustrates the linear relationship between boron concentration and required loading of NMDG to produce a stable cross-linked gel.

FIG. 13 illustrates gel viscosity results from the use of NMDG and no additional cross-linker with 200 ppm boron.

FIG. 14 illustrates gel viscosity results from the use of NMDG and no additional cross-linker with 500 ppm boron.

FIG. 15 illustrates gel viscosity results from the use of NMDG with guar 8.0 Lm-³ at 100° C.

FIG. 16 illustrates gel viscosity results from the use of NMDG and 1% ammonium persulfate (w/v).

FIG. 17 illustrates gel viscosity results using a breaker at 60° C. in 200 ppm of boron.

### DETAILED DESCRIPTION

The invention relates to methods and compositions for mitigating the presence of boron-containing species, and particularly borate, in water that is to be used to prepare a fracturing fluid. One of ordinary skill in the art will appreciate that the methods disclosed herein may be used for other oilfield applications where boron-containing water is problematic.

In one embodiment, the present invention comprises a method of mitigating the presence of boron-containing species in produced and recycled waters used for oil and gas well operations, particularly fracturing. In particular, one embodiment of the invention relates to the in-situ use of water-soluble borate chelating agents to sequester borate anions in boron contaminated water for oilfield use. The borate is not removed from the water, but is simply bound in a form which will not interfere with fluid performance.

In one embodiment, the invention comprises an aqueous fracturing fluid which is viscosified with a hydrated guar. This lightly viscosified fluid is referred to as a “linear gel” or “base fluid”, and is then cross-linked through association of its cis-hydroxyl groups with borate. When added to water, guar initially causes no gain in viscosity. Upon hydration of the guar by shearing the mixture, viscosity increases steadily to approximately 10 to 20 cP at 511 s⁻¹ after 10 minutes. When subsequently cross-linked, the fluid may have a viscosity of between 200 and 300 cP (at a shear rate of 100 s⁺¹) at formation temperature. The cross-linker is added to the linear gel as boric acid, although the active cross-linking species is the borate anion that is favored in an alkaline environment (Eq 1).

As used herein, and depending on context, the term “boron” includes boron-containing species in aqueous solution, and may refer to either boric acid or borate anion, which exist in equilibrium in aqueous solution.

B(OH)₃+[OH]⁻→[B(OH)₄]⁻ (Eq. 1)

In order to maximize the concentration of active cross-linker, an alkaline buffer comprising sodium hydroxide and/or potassium carbonate is added to the linear gel before cross-linking in order to increase the pH to at least about 9. Without restriction to a theory, it is thought that borate concentration is negligible below a pH of 7, increases rapidly at a pH of 8 until a pH of 10, at which point the equilibrium is almost entirely borate anion.

If there is an excess of borate during cross-linking, the gel becomes over cross-linked in a process referred to as “synerisis”. When over cross-linked, the gel network contracts, causing water to be extruded from the network. This is thought to be undesirable as it is expected that such a fluid will have poor proppant transport capability. From a qualitative perspective, such a gel looks ragged and fragile and the viscosity profile is inconsistent.

In embodiments of the present invention, a chelating agent is used to bind to the borate anion, and mitigate its disadvantageous effects. Chelating agents are multidentate ligands which form bonds or other attractive interactions between two or more separate binding sites within the same ligand and a single central atom or ion. In one embodiment, suitable chelating agents comprise a cis-diol moiety, and the chelating agents may be a sugar derivative. The viscosifying polymer in a gel may also comprise cis-diol moieties, but are not to be considered chelating agents herein. Therefore, suitable chelating agents may comprise non-polymeric cis-diol sugar derivatives containing an amine or amide group, an alkyl glucamine or an alkyl glucamide. In one embodiment, the chelating agent may comprise a polyhydric sugar alcohol such as sorbitol, mannitol and N-methyl-D-glucamine (NMDG), all of which are known to form complexes with borate. NMDG has the formula (I) shown here.

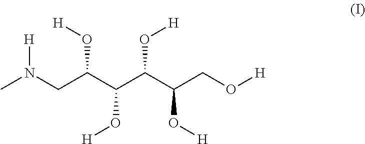

In one embodiment, NMDG is particularly useful for negating the effects of borate in water used for preparing fracturing fluids. NMDG may remediate base fluids containing boron, and may create stable cross-linked guar-based gels under a range of conditions.

While NMDG itself has no adverse effects on guar hydration, it raises the pH of a base fluid containing boron species out of the optimal range for hydration, therefore it is preferable to use an acidic buffer to achieve hydration. In one embodiment, the acidic buffer may comprise acetic acid, or another weak organic acid. Boron contaminated fluids require a pH less than about 7, preferably about pH 6, for guar hydration. It is to be noted that hydrated base fluids can be obtained by controlling boron species through acidifying the fluid alone, without the addition of a borate chelating agent. Control of pH is one method of controlling hydration of boron contaminated fluids if a linear gel, as opposed to a cross-linked gel, is the desired end product.

When preparing cross-linked gels from a linear gel, a stable cross-linked gel may not always result from adjusted loadings of acetic acid, alkaline buffer, and a borate cross-linker (BX1) at higher concentrations of boron contamination, such as in the 200-500 ppm range. In at least these cases, a borate chelating agent such as NMDG may remediate the presence of borate contamination, and produce a stable cross-linked gel. In a preferred embodiment, the invention comprises the addition of a NMDG solution after hydration of the polymer, such as a 50% w/v solution of NMDG. This may create a stable gel with reasonable loadings of other additives, such as buffers. The addition of a NMDG solution consistently delivered a stable cross-linked gel over multiple days of testing, demonstrating chemical stability over time.

NMDG/boron stoichiometry may have a significant effect on the stability of cross-linked guar gels. At approximately a 1:1 ratio at 60° C., a stable gel may be produced. However, increasing the ratio to 2:1 can result in a loss of stability. Therefore, the addition of excess borate chelating agent may not result in a suitable cross-linked gel.

In one embodiment, the boron contaminants, existing as borate anions in the base fluid, may be used as the cross-linking species to create a stable gel, eliminating the need to add extra cross-linker. This may be achieved by lowering the amount of NMDG loading to below a 1:1 ratio, such as 0.95:1 ratio or a 0.9:1 ratio.

In general, an NMDG loading that is either too low or too high will result in a fluid with less stable viscosity. In order to determine a suitable or optimal loading for any system, it is preferred to measure boron concentration and use a substantially stoichiometric amount of NMDG.

Suitable NMDG loadings may also be affected by temperature. In general, at higher temperatures, less chelating agent is required. At 100° C., loadings of NMDG significantly less than a stoichiometric ratio may still produce stable and acceptable cross-linked gels, compared to lower temperatures such as about 60° C.

NMDG continues to chelate borate even in the presence of high concentrations of salt, such as that found in produced water. Even in 20% w/v NaCl and base fluid with 100 ppm of boron contamination, NMDG allowed successful cross-linking. In fact, a high salt concentration may also permit a lower loading of NMDG.

NMDG-controlled systems may be broken using known breakers. Breaks comparable to the baseline were easily obtained by using a 1% solution of ammonium persulfate (w/v) (Breaker O) used in a conventional manner.

Based on these results, the use of NMDG in boron cross-linked fracturing fluids has been shown to be a consistent, effective technique for remediating base fluids with high concentrations of boron contamination. The loadings of other additives are within a reasonable range, and NMDG can be dissolved into a solution that can be pumped on the fly and is chemically stable over time. It is applicable over a range of temperatures, with testing done from 60-100° C., and a range of salinity, with testing done in fresh water and 20% NaCl w/v. It can be used to take advantage of the naturally occurring chemistry of produced waters and may allow the elimination of added boron cross-linker. It can also be broken using typical breakers at reasonable loadings.

### EXAMPLES

The following examples are intended to exemplify specific embodiments of the present invention, and not be limiting of the claimed invention.

### Example 1

### Baseline Buffered and Unbuffered Test Fluids

As a baseline, unbuffered test fluids were prepared with various boron concentrations of about 20, 60, 100, 200 and 500 ppm (mg/L). Various amounts of a solution of a sodium salt of boric acid (referred to herein as BX1), was used to achieve test concentrations of boron, which were then used to simulate a boron contaminated fluid. As used herein, BX1 has an alkaline pH as it includes an amount of sodium hydroxide to neutralize the acidity of the solution. The final pH of the simulated boron contaminated fluid, being unbuffered, increases to a maximum of about 8.5.

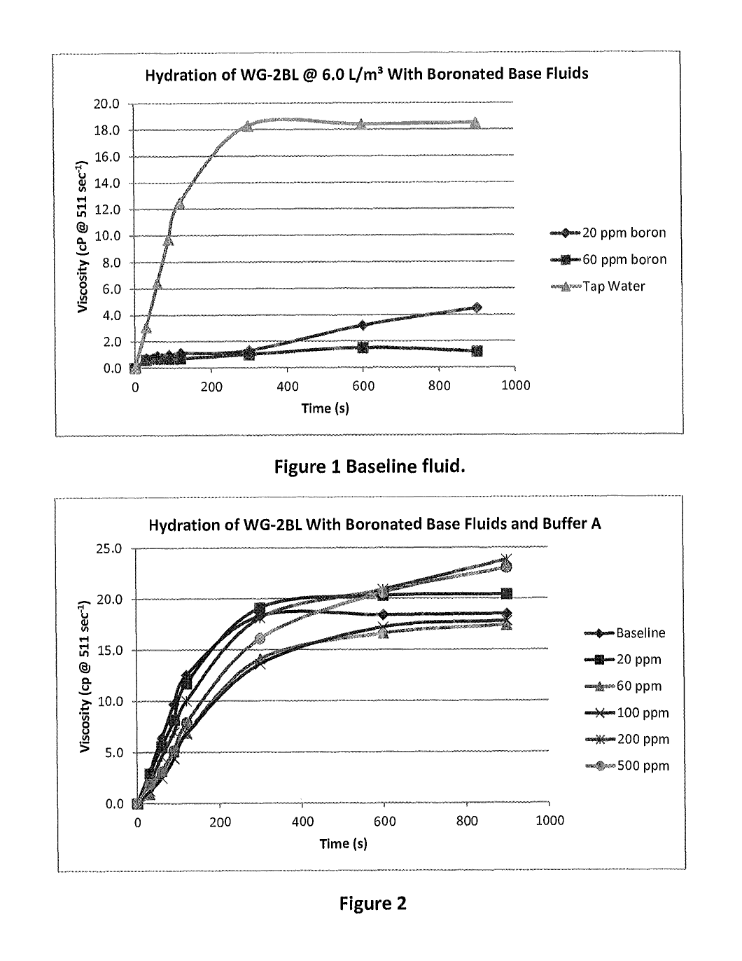

This artificially contaminated fluid was used with guar (6.0 L/m³ of an approximately 50% w/v guar slurried in mineral oil) to prepare a gel for fracturing and the resulting viscosities are shown below in Table 1 and in FIG. 1. In this experiment, the fluid prepared with potable tap water had successful hydration, but the presence of boron in low concentrations, without pH control, inhibited hydration and the resultant fluid did not significantly viscosify over a period of about 15 minutes.

TABLE 1

| Base Fluid | guar (L/m³) | pH | Final Viscosity (cP @ 511 sec⁻¹) |
|---|---|---|---|
| Tap Water | 6.0 | 6.5 | 18.5 |
| 20 ppm Boron | 6.0 | 6.5 | 4.5 |
| 60 ppm Boron | 6.0 | 7.0 | 1.2 |

When the same test fluid with boron contamination was buffered to pH 6 with acetic acid, significant viscosity developed at all concentrations of boron. Thus, guar hydration could be carried out successfully in the presence of boron when an acidic pH is maintained, as demonstrated in Table 2 and FIG. 2. As the level of boron concentration increases, so does the amount of acid buffer required to maintain a pH of about 6.0.

TABLE 2
60% (v:v) solution of acetic acid used achieve hydration

| | Acetic acid | | | Base Fluid |
|---|---|---|---|---|
| Base Fluid | (L/m³) | guar (L/m³) | pH | Viscosity (cP @ 511 sec⁻¹) |
| Tap Water | 0.0 | 6.0 | 6.5 | 18.5 |
| 20 ppm | 0.2 | 6.0 | 6.0 | 20.4 |
| Boron | | | | |
| 60 ppm | 0.5 | 6.0 | 6.0 | 17.4 |
| Boron | | | | |
| 100 ppm | 0.9 | 6.0 | 6.0 | 17.8 |
| Boron | | | | |
| 200 ppm | 1.9 | 6.0 | 6.0 | 23.8 |
| Boron | | | | |
| 500 ppm | 4.8 | 6.0 | 6.0 | 23 |
| Boron | | | | |

### Example 2

### Effect of NMDG

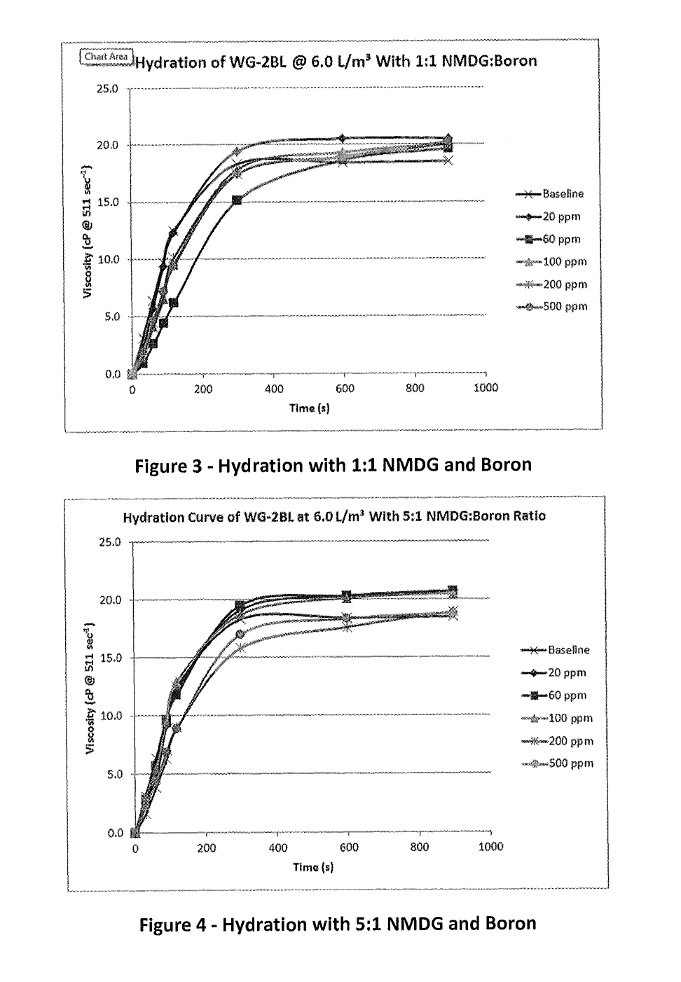

Solutions of NMDG and boron were prepared in a 1:1 molar ratio. A buffer was used to control the pH to 6.0 in the amounts shown in Table 3. The results show that the guar hydrated at all concentrations of NMDG and boron (FIG. 3).

TABLE 3
Hydration with NMDG at a 1:1 ratio with boron

| | NMDG | Acetic acid | guar | | Base Fluid Viscosity |
|---|---|---|---|---|---|
| Base Fluid | (g/L) | (L/m³) | (L/m³) | pH | (cP @ 511 sec⁻¹) |
| Tap Water | 0.0 | 0.0 | 6.0 | 6.5 | 18.5 |
| 20 ppm | 0.3774 | 0.2 | 6.0 | 6.0 | 20.5 |
| Boron | | | | | |
| 60 ppm | 1.1249 | 0.4 | 6.0 | 6.0 | 19.6 |
| Boron | | | | | |
| 100 ppm | 1.8958 | 1.4 | 6.0 | 6.0 | 20.0 |
| Boron | | | | | |
| 200 ppm | 3.7195 | 3.0 | 6.0 | 6.0 | 20.0 |
| Boron | | | | | |
| 500 ppm | 9.3348 | 8.0 | 6.0 | 6.5 | 20.2 |
| Boron | | | | | |

Further experiments were conducted by varying the NMDG:boron ratios and similar results were obtained. FIG. 4 shows the results of 5:1 NMDG:boron ratio fluids, and the resulting fluids had nearly the same viscosity response as the baseline control fluid.

### Example 3

### Boron Remediation in Cross-Linked Fluids

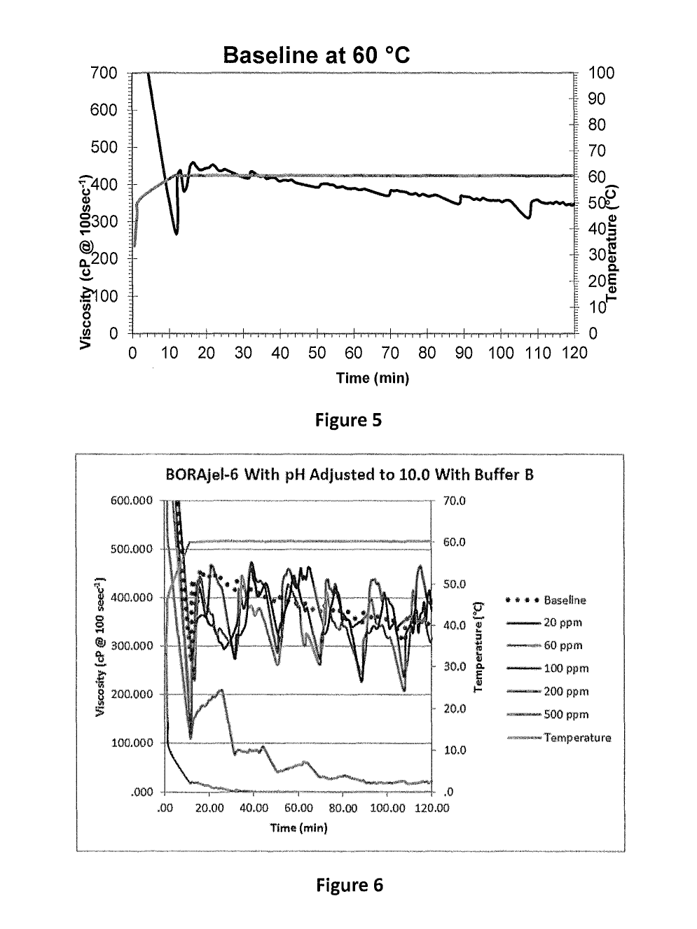

In order to measure the effect of boron contamination on cross-linking performance, it was necessary to establish a baseline. Baseline gel stability of a standardized borate cross-linked fluid at 60° C. (approximately 50% w/v guar at 6.0 Lm⁻³, alkaline buffer at 1.5 Lm⁻³, and BX1 at 1.5 Lm⁻³) is shown in FIG. 5. All further testing was compared to this baseline.

To determine the level of boron contamination which interfered with successful gel cross-linking, a gel prepared with 6 Lm⁻³ of approximately 50% w/v guar was prepared in each base fluid (with boron contamination ranging from 20 to 500 ppm). Acetic acid was first added to achieve guar hydration, and subsequently alkaline buffer was added in an amount sufficient to consistently achieve a pH of 10. The results of this testing are shown in FIG. 6 and alkaline buffer loadings are shown in Table 4.

TABLE 4
Alkaline buffer required to achieve pH 10

| Boron | Alkaline |
|---|---|
| (ppm) | buffer (L/m³) |
| 20 | 1.5 |
| 60 | 3.0 |
| 100 | 5.5 |
| 200 | 12.0 |
| 500 | 30.0 |

As seen in FIG. 6, all concentrations of boron contamination in the base fluid led to some degree of deterioration in gel quality as evidenced by the inconsistent viscosity of these curves. Such fluctuations in viscosity are often described as “over cross-linking” as this type of inconsistent rheological behavior is often encountered when an excess of cross-linker is present. At 20, 60, and 100 ppm, the gels appeared over cross-linked and demonstrated inconsistent viscosity compared to the baseline. At 200 and 500 ppm, the gels did not maintain viscosity at all.

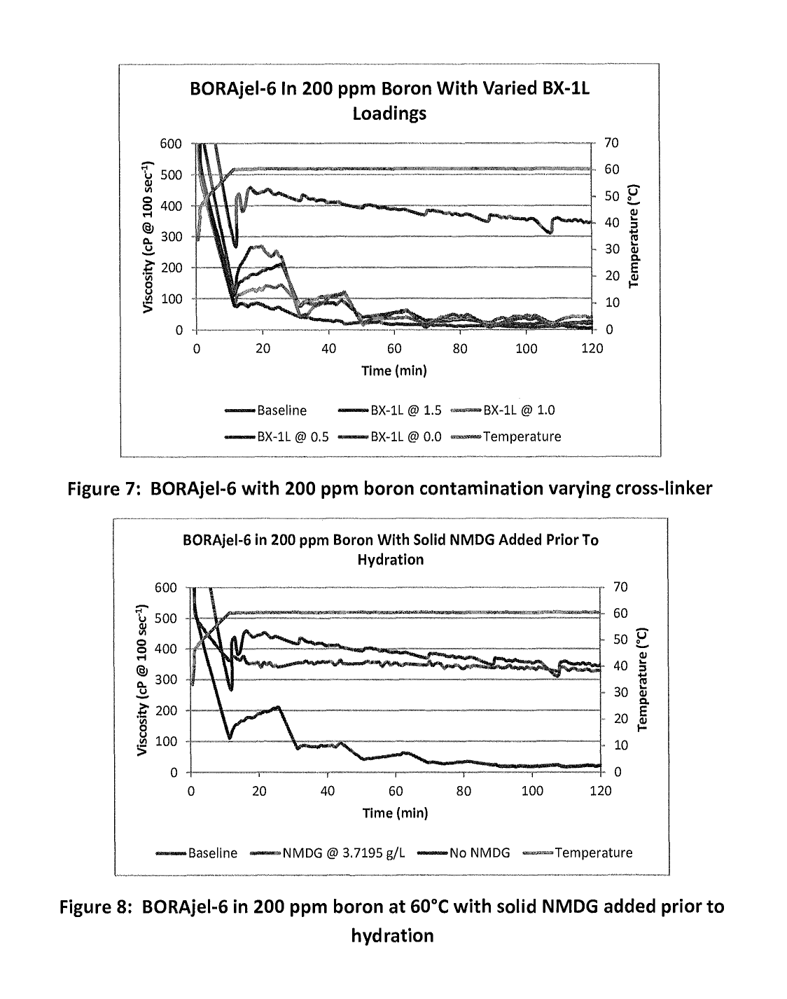

Cross-linker loadings were decreased to investigate whether increased boron contamination could be off-set by reducing the amount of additional boron in solution. A series of gels was prepared from water contaminated with 20 ppm boron (contains approximately the same amount of boron as 1.0 Lm⁻³ of BX1). The loading of cross-linker added to these gels (after hydration) was varied in 0.5 Lm⁻³ increments from 0 to 1.5 Lm⁻³. In the presence of 20 ppm boron contamination, a stable gel could be prepared with the addition of 0.5 Lm⁻³ BX1. Further addition of cross-linker produced an over cross-linked gel with unstable viscosity. In the presence of 60, 100, 200, and 500 ppm boron contamination it was not possible to produce a gel comparable to the baseline by reducing the amount of cross-linker added following gel hydration. The results using 200 ppm boron are shown in Table 5 below, and FIG. 7.

TABLE 5
Composition of fluids prepared in presence of 200 ppm boron contamination

| | Acetic | | Alkaline | | | Base Fluid | Average Gel |
|---|---|---|---|---|---|---|---|
| | acid | guar | buffer | BX1 | | Viscosity (cP @ | Viscosity |
| Base Fluid | (L/m³) | (L/m³) | (L/m³) | (L/m³) | pH | 511 sec⁻¹) | (cP @ 100 sec⁻¹) |
| Tap Water | 0.0 | 6.0 | 1.5 | 1.5 | 9 | 18.5 | 387 |
| 200 ppm | 1.9 | 6.0 | 12.0 | 1.5 | 10 | 19.0 | 80 |
| Boron | | | | | | | |
| 200 ppm | 1.9 | 6.0 | 12.0 | 1.0 | 10 | 19.0 | 22 |
| Boron | | | | | | | |
| 200 ppm | 1.9 | 6.0 | 12.0 | 0.5 | 10 | 19.0 | 44 |
| Boron | | | | | | | |
| 200 ppm | 1.9 | 6.0 | 12.0 | 0.0 | 10 | 19.0 | 91 |
| Boron | | | | | | | |

### Example 4

### Effect of NMDG on Boron Interference

As the guar gels with 200 ppm of boron contamination in the base fluid, buffered to pH 10, showed significantly decreased viscosity when attempting cross-linking, this concentration was chosen for the initial development and optimization of a stable system using NMDG.

A 1:1 molar ratio of NMDG:Boron was added to the base fluid prior to hydration. The pH was adjusted to 6.0 with 3.0 L/m³ acetic acid for hydration. After hydration, tests were run with varied levels of alkaline buffer. At a loading of 8.0 L/m³ of alkaline buffer (pH of 10.0), a comparable viscosity to the baseline was produced.

The results are shown in FIG. 8. As may be seen, the addition of about 3.7 g/L of solid NMDG, molar equivalent to 200 ppm boron, resulted in viscosity development substantially better than a control run without NMDG. While the viscosity was slightly reduced compared to baseline, this gap narrowed over time.

### Example 5

### Order of Addition

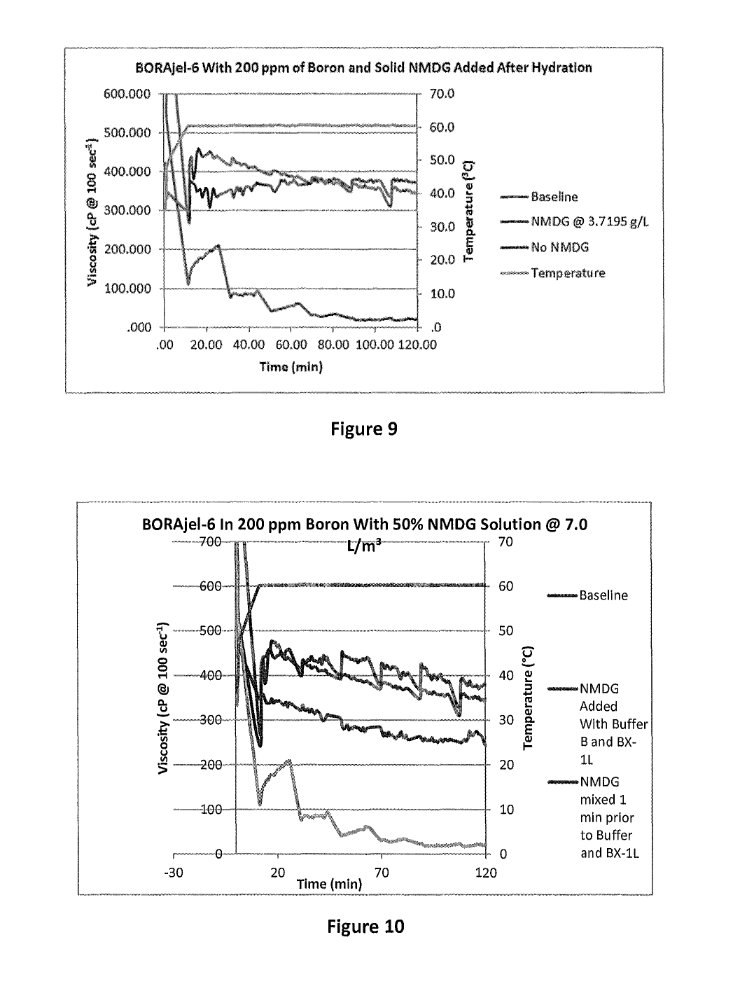

A test was then done with the same NMDG loading, but with a change in the order of addition. Hydration was controlled through pH control with acetic acid, and solid NMDG was added after hydration was complete. It was allowed to mix briefly before the addition of alkaline buffer and BX1. A loading of 3.0 Lm⁻³ of alkaline buffer increased the pH to 10.0. The results are shown in FIG. 9, and are similar to those seen in FIG. 8, where NMDG was added before hydration. It appears that NMDG can effectively produce a stable cross-linked gel when added before or after hydration.

A solution of 50% NMDG w/v in tap water was created by dissolving 50 g NMDG in 100 mL water and added at a range of different loadings prior to cross-linking. A loading of 7.0 L/m³ was found to produce the best results. When mixed for 1 minute before adding alkaline buffer and BX-1, a gel with an ideal, smooth lip was formed, whereas adding the NMDG at the same time as alkaline buffer and BX1 produced an over cross-linked lip. However, simultaneous addition produced increased viscosity over time, as may be seen in FIG. 10.

Without restriction to a theory, a temperature-dependent equilibrium may cause both the concentration of the borate anion and NMDG activity to change with temperature. As a result, mixing the NMDG initially produces a good cross-link at room temperature, but leads to undercross-linking at 60° C.

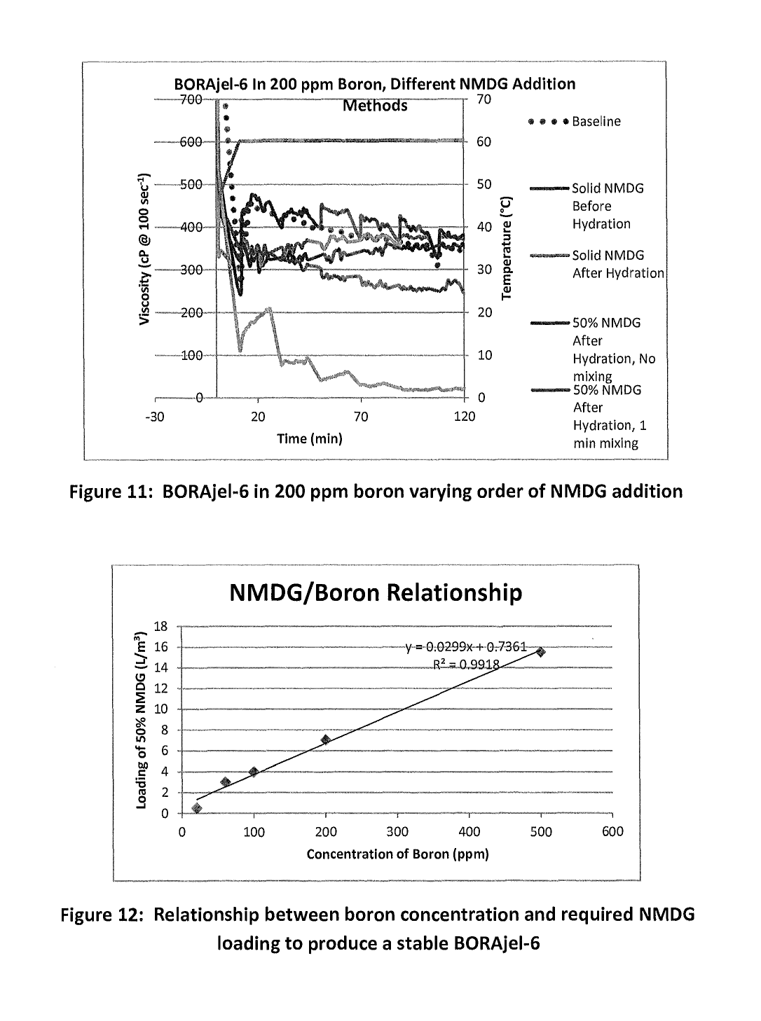

A comparison was made between the effectiveness of solid NMDG versus NMDG in solution at remediating boron contamination. The effect of changing the order of addition was also compared, and the results shown in Table 6, and FIG. 11. Use of the 50% NMDG solution, added without extra mixing, was determined to produce the most comparable gel to the baseline. FIG. 11 shows how different methods of NMDG addition compare.

TABLE 6
Fluid compositions for FIG. 11

| | | | | | | | | | | Average |
|---|---|---|---|---|---|---|---|---|---|---|
| | Method | | | | | | | | | Gel |
| | of | | Acetic | | 50% | Alkaline | | | Base Fluid | Viscosity |
| Base | NMDG | NMDG | acid | GUAR | NMDG w/v | buffer | BX1 | | Viscosity | (cP @ |
| Fluid | Addition | (g/L) | (L/m³) | (L/m³) | (L/m³) | (L/m³) | (L/m³) | pH | (cP @ 511 sec⁻¹) | 100 sec⁻¹) |
| Tap | none | 0.0 | 0.0 | 6.0 | 0.0 | 1.5 | 1.5 | 9.0 | 18.5 | 387 |
| Water | | | | | | | | | | |
| 200 ppm | none | 0.0 | 1.9 | 6.0 | 0.0 | 12.0 | 1.5 | 10.0 | 19.0 | 80 |
| Boron | | | | | | | | | | |
| 200 ppm | Solid | 3.7195 | 3.0 | 6.0 | 0.0 | 9.0 | 1.5 | 9.5 | 15.2 | 350 |
| Boron | Before | | | | | | | | | |
| | Hydration | | | | | | | | | |
| 200 ppm | Solid | 3.7195 | 1.9 | 6.0 | 0.0 | 3.0 | 1.5 | 10.5 | 16.7 | 325 |
| Boron | After | | | | | | | | | |
| | Hydration | | | | | | | | | |
| 200 ppm | Liquid, | 0.0 | 1.9 | 6.0 | 7.0 | 3.0 | 1.5 | 10.0 | 16.2 | 416 |
| Boron | no extra | | | | | | | | | |
| | mixing | | | | | | | | | |
| 200 ppm | Liquid, 1 min | 0.0 | 1.9 | 6.0 | 7.0 | 3.0 | 1.5 | 10.0 | 16.2 | 263 |
| Boron | extra | | | | | | | | | |
| | mixing | | | | | | | | | |

### Example 6

### Effective Amount of NMDG (Stoichiometry with Boron)

The method of adding a solution of 50 wt % NMDG with no additional mixing was shown to be the most effective way to remediate 200 ppm boron contamination. Therefore, the same method was used to determine optimum stoichiometry for base fluids contaminated with 20, 60, 100, and 500 ppm boron. The 50% NMDG solution delivered consistent results over multiple days of testing, which showed that the solution is chemically stable over time and did not need to be re-mixed on a daily basis.

For each base fluid with different boron concentration, an effective loading of 50 wt % NMDG which resulted in viscosity of the cross-linked guar similar to baseline was determined, along with an effective amount of alkaline buffer to achieve a final pH of 10.0 for each system, as shown in Table 7 below. At each concentration of boron, NMDG offered an improvement in stability and comparable performance to the baseline tests done in tap water.

TABLE 7
Effective loadings of NMDG for a given boron concentration

| Boron | guar | Acetic acid | 50% NMDG | Alkaline | BX1 |
|---|---|---|---|---|---|
| (ppm) | (L/m³) | (L/m³) | (L/m³) | buffer (L/m³) | (L/m³) |
| 20 | 6.0 | 0.2 | 0.5 | 1.0 | 1.5 |
| 60 | 6.0 | 0.5 | 3.0 | 1.5 | 1.5 |
| 100 | 6.0 | 1.0 | 4.0 | 2.5 | 1.5 |
| 200 | 6.0 | 1.9 | 7.0 | 3.0 | 1.5 |
| 500 | 6.0 | 5.0 | 15.5 | 3.0 | 1.5 |

The viscosity of the fluid comes from cross-linking a guar polymer network with a borate anion cross-linker. The ratio of polymer to cross-linker dictates many of the gel qualities. Too high a cross-linker:polymer ratio results in a brittle gel that is termed “over cross-linked” as described above. Too low a cross-linker:polymer ratio results in a weak gel with low viscosity. Similarly, the ratio of NMDG:borate affects gel quality as excess NMDG will sequester all borate species, including those necessary to cross-link to obtain a stable gel. This will result in a low viscosity gel being obtained. However, insufficient addition of NMDG will not sequester all of the contaminating boron species from solution, and excess available borate will then cross-link with guar, thereby causing the gel to become over cross-linked. As seen in Table 7 above and FIG. 12, the relationship between boron contamination and optimum NMDG loading for boron chelation is linear at 60° C.

Test results with a 2:1 ratio of NMDG to boron show that an excess of NMDG results in significant deterioration in performance, as seen in Table 8 below.

TABLE 8
Fluid composition varying NMDG stoichiometry

| | | Acetic | | Alkaline | | | | |
|---|---|---|---|---|---|---|---|---|
| | NMDG | acid | GUAR | buffer | BX1 | | Base Fluid Viscosity | Average Gel Viscosity |
| Base Fluid | (g/L) | (L/m³) | (L/m³) | (L/m³) | (L/m³) | pH | (cP @ 511 sec⁻¹) | (cP @ 100 sec⁻¹) |
| Tap Water | 0.0 | 0.0 | 6.0 | 1.5 | 1.5 | 9.0 | 18.5 | 387 |
| 200 ppm | 0.0 | 1.9 | 6.0 | 3.0 | 1.5 | 10.0 | 19.0 | 80 |
| Boron | | | | | | | | |
| 200 ppm | 3.7195 | 1.9 | 6.0 | 3.0 | 1.5 | 10.0 | 16.7 | 325 |
| Boron | | | | | | | | |
| 200 ppm | 7.4390 | 1.9 | 6.0 | 3.0 | 1.5 | 10.0 | 17.4 | 16 |
| Boron | | | | | | | | |

### Example 7

### Use of Boron Contaminants as Cross-Linker Controlled by NMDG

Due to the fact that the boron species already existing in water have been shown to contribute to gel cross-linking, stable gel systems at 200 ppm boron and 500 ppm boron were developed by reducing the amount of NMDG added, and eliminating the need for further addition of cross-linker.

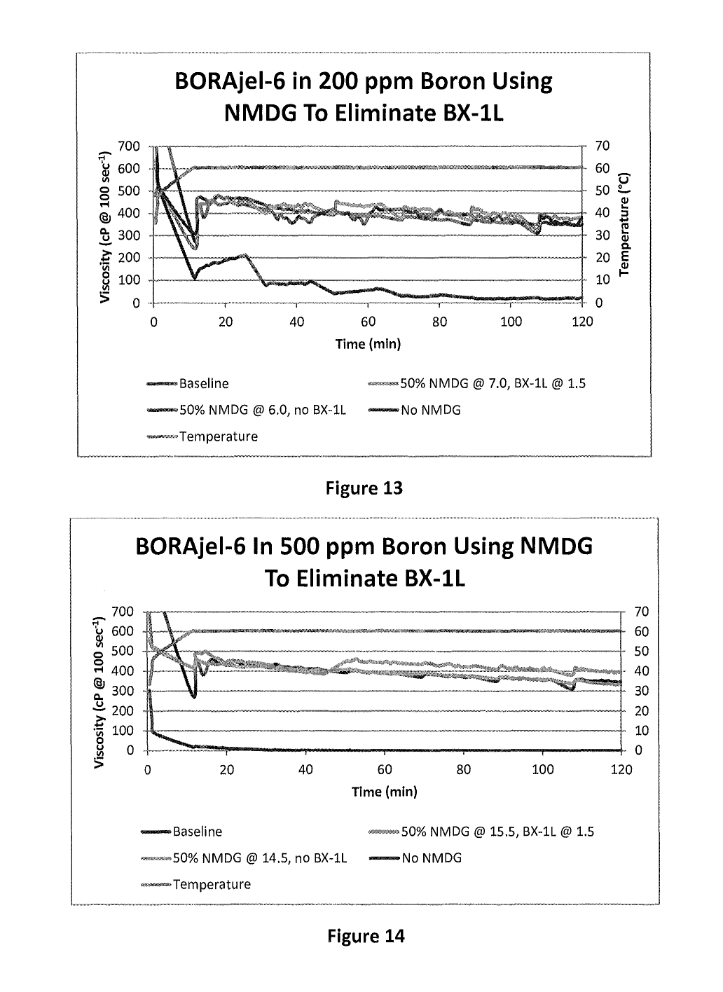

In the testing described above, BX1 was added at 1.5 Lm⁻³ which is equivalent to approximately 30 ppm of boron. Assuming a 1:1 stoichiometry when boron complexes with NMDG, 30 ppm of boron should be adequately sequestered by 0.5 g/mL of NMDG (1.0 Lm⁻³ of 50% w/v NMDG solution). A series of cross-linked guar gels were prepared where the loadings of NMDG were reduced and no cross-linker (BX1) was added following guar hydration. The results of this testing in base fluid contaminated with 200 and 500 ppm boron are shown in FIGS. 13 and 14 respectively. Fluid compositions are provided in Tables 9 and 10.

TABLE 9
Fluid composition without BX1 and reducing NMDG

| | | Acetic | | Alkaline | | | Base Fluid | |
|---|---|---|---|---|---|---|---|---|
| Base | 50% NMDG | acid | GUAR | buffer | BX1 | | Viscosity (cP @ | Average Gel Viscosity |
| Fluid | w/v (L/m³) | (L/m³) | (L/m³) | (L/m³) | (L/m³) | pH | 511 sec⁻¹) | (cP @ 100 sec⁻¹) |
| Tap | 0.0 | 0.0 | 6.0 | 1.5 | 1.5 | 9.0 | 18.5 | 387 |
| Water | | | | | | | | |
| 200 ppm | 0.0 | 1.9 | 6.0 | 3.0 | 1.5 | 10.0 | 19.0 | 80 |
| Boron | | | | | | | | |
| 200 ppm | 7.0 | 1.9 | 6.0 | 3.0 | 1.5 | 10.0 | 16.2 | 416 |
| Boron | | | | | | | | |
| 200 ppm | 6.0 | 1.9 | 6.0 | 3.0 | 0.0 | 10.0 | 16.7 | 391 |
| Boron | | | | | | | | |

TABLE 10
Fluid composition without BX1 and reducing NMDG

| | | Acetic | | Alkaline | | | Base Fluid | |
|---|---|---|---|---|---|---|---|---|
| Base | 50% NMDG | acid | GUAR | buffer | BX1 | | Viscosity (cP @ | Average Gel Viscosity |
| Fluid | w/v (L/m³) | (L/m³) | (L/m³) | (L/m³) | (L/m³) | pH | 511 sec⁻¹) | (cP @ 100 sec⁻¹) |
| Tap | 0.0 | 0.0 | 6.0 | 1.5 | 1.5 | 9.0 | 18.5 | 387 |
| Water | | | | | | | | |
| 500 ppm | 0.0 | 5.0 | 6.0 | 1.5 | 1.5 | 10.0 | 19.0 | 80 |
| Boron | | | | | | | | |
| 500 ppm | 15.5 | 4.8 | 6.0 | 3.0 | 1.5 | 10.0 | 16.5 | 428 |
| Boron | | | | | | | | |
| 500 ppm | 14.5 | 5.0 | 6.0 | 3.0 | 0.0 | 7.0 | 16.3 | 385 |
| Boron | | | | | | | | |

As seen in this data, fluids that were cross-linked using existing boron contaminants controlled solely through the addition of NMDG, without additional cross-linker, performed equally to or better than fluids that were controlled through the addition of both NMDG and the BX1 cross-linker.

### Example 8

### Studies at 100° C.

All testing of boron sequestration by NMDG described above was carried out at 60° C. This example describes testing carried out at 100° C. and was completed in order to investigate whether NMDG could be applied over a range of temperatures.

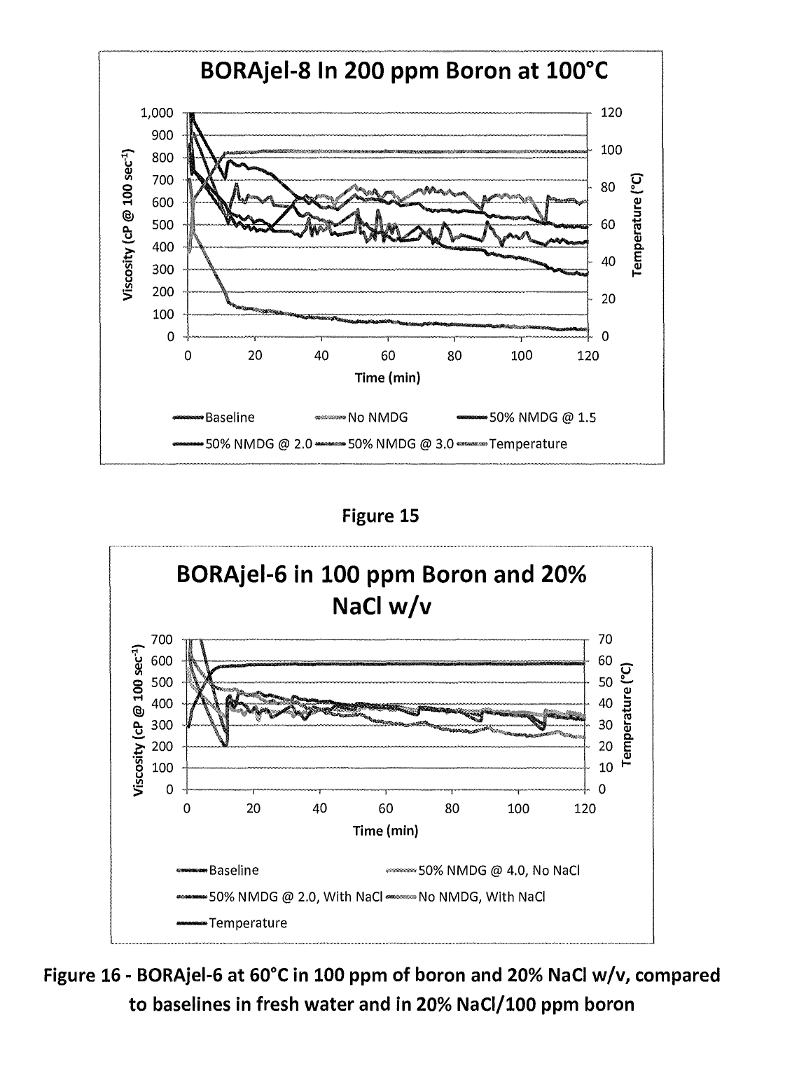

Initial 100° C. testing of the standardized cross-linked guar fluid in 200 ppm boron contaminated water was unsuccessful in producing a stable gel regardless of NMDG loading, therefore the guar loading was increased to 8.0 Lm⁻³ and the cross-linker (BX1) loading was increased to 2.5 Lm⁻³. The results of testing with varying NMDG loadings are shown in FIG. 15. Fluid composition is provided in Table 11,

TABLE 11
Fluid composition varying NMDG loading

| | | Acetic | | Alkaline | | | | |
|---|---|---|---|---|---|---|---|---|
| Base | 50% NMDG | acid | GUAR | buffer | BX1 | | Base Fluid Viscosity | Average Gel Viscosity |
| Fluid | w/v (L/m³) | (L/m³) | (L/m³) | (L/m³) | (L/m³) | pH | (cP @ 511 sec⁻¹) | (cP @ 100 sec⁻¹) |
| Tap | 0.0 | 0.0 | 8.0 | 2.5 | 2.5 | 10 | 29.1 | 476 |
| Water | | | | | | | | |
| 200 ppm | 0.0 | 1.9 | 8.0 | 2.5 | 2.5 | 8 | 29.0 | 630 |
| Boron | | | | | | | | |
| 200 ppm | 1.5 | 1.9 | 8.0 | 6.0 | 0.0 | 9 | 29.0 | 605 |
| Boron | | | | | | | | |
| 200 ppm | 2.0 | 1.9 | 8.0 | 6.0 | 0.0 | 9 | 26.5 | 444 |
| Boron | | | | | | | | |
| 200 ppm | 3.0 | 1.9 | 8.0 | 5.0 | 0.0 | 10 | 26.5 | 75 |
| Boron | | | | | | | | |

This data demonstrates that NMDG is efficient at chelating borate over a range of temperatures, and that the optimum stoichiometry may be temperature dependent.

### Example 9

### Effect of Brine on the Reaction Between Boron and NMDG

Many produced waters also contain high concentrations of salts, therefore, in order to test the effects of brine on NMDG chelating ability, tests were carried out to create a stable fluid using 6 Lm⁻³ guar in 100 ppm of boron and 20% NaCl w/v, and compare that fluid to the baseline (that was prepared in fresh water with no boron contamination). A 20% sodium chloride (NaCl) solution was prepared by adding 200 g of NaCl to 1000 mL Calgary tap water. This solution was contaminated with 100 ppm boron. A comparison was also made to a similar cross-linked guar fluid without brine in 100 ppm boron. Fluid compositions are provided in Table 12.

TABLE 12
Fluid composition in 20% NaCl

| | | | Acetic | | Alkaline | | | Base Fluid | |
|---|---|---|---|---|---|---|---|---|---|
| Base | % NaCl | 50% NMDG | acid | GUAR | buffer | BX1 | | Viscosity (cP @ | Average Gel Viscosity |
| Fluid | (w/v) | w/v (L/m³) | (L/m³) | (L/m³) | (L/m³) | (L/m³) | pH | 511 sec⁻¹) | (cP @ 100 sec⁻¹) |
| Tap | 0 | 0.0 | 0.0 | 6.0 | 1.5 | 1.5 | 9 | 18.5 | 387 |
| Water | | | | | | | | | |
| 100 ppm | 0 | 4.0 | 1.0 | 6.0 | 2.5 | 1.5 | 10 | 16.1 | 367 |
| Boron | | | | | | | | | |
| 100 ppm | 20 | 2.0 | 1.0 | 6.0 | 4.0 | 1.5 | 10 | 15.6 | 372 |
| Boron | | | | | | | | | |

As may be seen in Table 12 and FIG. 16, stable cross-linked gels may be prepared with 6 Lm⁻³ guar in 20% NaCl solution.

### Example 10

### Break Tests with NMDG-Controlled Cross-Linked Guar

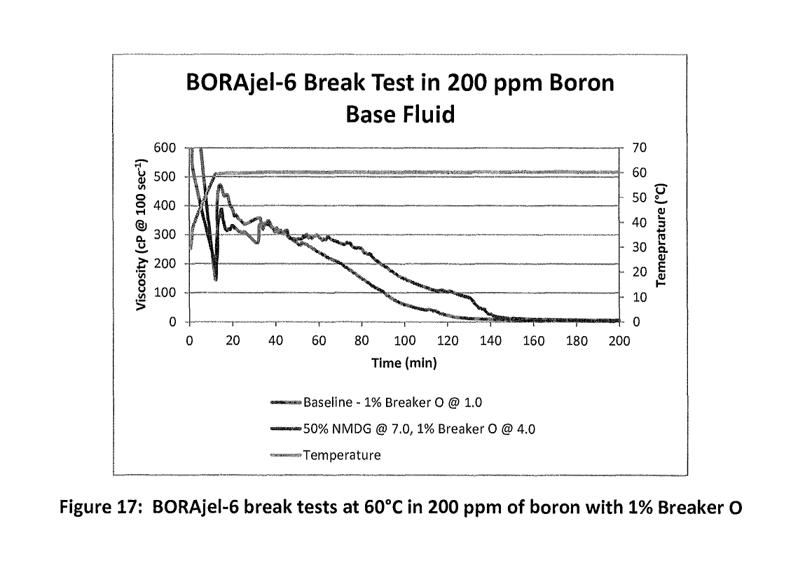

In order to be assured that NMDG-controlled cross-linked guar fluids are viable fluid systems, it is important to be sure that they can be broken. Break tests were conducted at 60° C. in 200 ppm base fluid using a 1% solution of ammonium persulfate (Breaker O) and were compared to baseline break tests in tap water. Test results are shown in Table 13 and FIG. 17.

TABLE 13
Fluid composition for break tests

| | 50% | | | | | | | | Average | |
|---|---|---|---|---|---|---|---|---|---|---|
| | NMDG | Acetic | | Alkaline | | | | Base Fluid | Gel | Time to |
| Base | w/v | acid | GUAR | buffer | | 1% Br—O | | Viscosity | Viscosity | Break (15 cP |
| Fluid | (L/m³) | (L/m³) | (L/m³) | (L/m³) | BX1 (L/m³) | (L/m³) | pH | (cP @ 511 sec⁻¹) | (cP @ 100 sec⁻¹) | @ 100 sec⁻¹) |
| Tap | 0.0 | 0.0 | 6.0 | 1.5 | 1.5 | 1.0 | 10 | 17.0 | 97 | 2 h 7 min |
| Water | | | | | | | | | | |
| 200 ppm | 7.0 | 1.9 | 6.0 | 3.0 | 1.5 | 4.0 | 10 | 18.2 | 119 | 2 h 26 min |
| Boron | | | | | | | | | | |

Although the NMDG system required more breaker in order to reach an equivalent break time, the loadings were still within a reasonable range. The break was controlled and adheres well to the baseline test done in tap water, showing that cross-linked guar systems controlled by NMDG can still be broken.

### DEFINITIONS AND INTERPRETATION

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to combine, affect or connect such aspect, feature, structure, or characteristic with other embodiments, whether or not such connection or combination is explicitly described. In other words, any element or feature may be combined with any other element or feature in different embodiments, unless there is an obvious or inherent incompatibility between the two, or it is specifically excluded.

The singular forms “a,” “an,” and “the” include the plural reference unless the context clearly dictates otherwise. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation.

The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

An “effective amount” refers to an amount effective to bring about a recited effect.

What is claimed is:

1. A fracturing fluid for stimulating a wellbore comprising:
a. an aqueous base fluid comprising boron;
b. a hydrated polysaccharide gelling agent; and
c. a non-polymer borate chelating agent comprising a cis-diol moiety.

2. The fracturing fluid of claim 1 wherein the chelating agent further comprises an amine or amide group.

3. The fracturing fluid of claim 2 wherein the chelating agent comprises a polyhydric sugar alcohol.

4. The fracturing fluid of claim 3 wherein the chelating agent comprises NMDG and the polysaccharide gelling agent comprises guar or a guar derivative.

5. The fracturing fluid of claim 1 further comprising a boron cross-linking agent.

6. The fracturing fluid of claim 1 wherein the aqueous base fluid comprises produced or recycled water.

7. A method of producing a fracturing fluid, comprising the steps of:
a. using water comprising boron, hydrating a polysaccharide gelling agent by: (i) reducing the pH to less than about 7, or (ii) adding a non-polymer boron chelating agent comprising a cis-diol moiety and adjusting pH to less than about 8;
b. cross-linking the polysaccharide gelling agent by increasing the pH to greater than about 9, optionally with the addition of a boron cross-linking agent, and controlling boron with the borate chelating agent added in step (a) or additional borate chelating agent.

8. The method of claim 7 wherein the chelating agent further comprises an amine or amide group.

9. The method of claim 7 wherein the chelating agent comprises a polyhydric sugar alcohol.

10. The method of claim 9 wherein the chelating agent comprises NMDG and the polysaccharide gelling agent comprises guar or a guar derivative.

11. The method of claim 7 wherein a boron cross-linking agent is added in step (b).

12. The method of claim 7 wherein the amount of boron in the fluid is known, and the amount of borate chelating agent is adjusted to about 1:1 molar ratio with boron.

13. The method of claim 7 wherein no boron cross-linking agent is added in step (b), and the gelling agent is cross-linked with existing boron in the water, wherein excess boron is controlled with the boron chelating agent.

14. The method of claim 7 wherein the water comprising boron comprises produced or recycled water.

15. A method of stimulating a wellbore using a fracturing fluid comprising water comprising boron, comprising the steps of:
a. hydrating a polysaccharide gelling agent at a pH of less than about 8;
b. adding a boron chelating agent before or after hydration;
c. cross-linking the polysaccharide gelling agent by increasing the pH to greater than about 9.

16. The method of claim 15 wherein the gelling agent is cross-linked without the addition of a boron cross-linking agent.

17. The method of claim 15 wherein the water comprising boron is recycled or produced water, the amount of boron is known, and the amount of boron chelating agent is added in an amount sufficient to allow existing boron to cross-link the gelling agent, while excess boron is controlled.

18. The method of claim 15 wherein the pH is increased by adding an alkaline buffer and the boron chelating agent is added and mixed prior to adding the alkaline buffer.

19. The method of claim 15 wherein the boron chelating agent is added as an aqueous solution or as a solid.
